(19) United States
(12) Patent Application Publication
(10) Pub. No.: US 2007/0050496 A1
(43) Pub. Date: Mar. 1, 2007

(54) Ad-hoc network, a network device and a method of configuration management therefor

(75) Inventors: Wilhelmus Franciscus Johannes Fontijn, Eindhoven (NL); Adrianus Johannes Maria Denissen, Eindhoven (NL); Nicolaas Lambert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/554,616

(22) PCT Filed: Apr. 28, 2004
(86) PCT No.: PCT/IB04/50540

§ 371 Date: Oct. 27, 2005

(30) Foreign Application Priority Data
May 1, 2003 (EP) 03101208.1

(51) Int. Cl. G06F 15/173

(52) U.S. Cl. 709/224

(57) ABSTRACT

The invention relates to an ad-hoc network (100) comprising a network device (201) for configuration management. The network device (201) comprises a traffic monitoring processor (211) which monitors traffic between different network elements. The network device (201) further comprises a configuration processor (213) which determines combined configuration information for at least a first and second network element in response to the monitored traffic. The combined configuration information is stored in a data store (215) and may be communicated to other network elements. The network device (201) may thus derive combined configuration information which relates to more than one network element and may specifically determine combined configuration information in the context of location, connections and history of the ad-hoc network (100). The stored combined configuration information may be used to initiate a replacement network element or to emulate the functionality of an existing network element. It may also be used for error detection.

The invention relates to an ad-hoc network, a network device and a method of configuration management therefor and in particular to dynamic ad-hoc networks comprising a plurality of intelligent devices.

In recent years, networks for communication have become increasingly widespread. Previously, networks tended to be communication networks used for telecommunication or data networks used for communication between computers. These networks are typically used for well defined and predictable applications and environments. Specifically, the network elements are typically well defined and have a high degree of homogeneity. Furthermore, these networks tend to be relatively static and modifications and alterations occur infrequently.

These properties make such networks well suited for centralized management and monitoring and they are typically controlled and managed be relatively few and central management and operations network elements. For example, the Internet uses a few central databases for relating URLs (Uniform resource Locator) to IP (Internet Protocol) addresses. As another example, communication networks as used in cellular communication systems typically comprise a central operations and management center.

However, in recent years a new type of networks known as ad-hoc networks has emerged. Ad-hoc networks are typically dynamic networks which are made up by communication links established between various devices. The communication links are formed as and when conditions allow these to be formed, and the configuration of the ad-hoc network thus changes continuously as devices enter and leave the network.

Ad-hoc networks may be wired or wireless networks or a combination of these. For example, wireless standards such as Bluetooth networks or IEEE 802.11b, which are suitable for wireless ad-hoc networks, have been developed. In accordance with these standards, devices comprising, for example, IEEE 802.11b functionality continuously monitor the radio frequencies to detect if any other IEEE 802.11b devices are sufficiently close. If such a device is detected, a communication link is formed between them. In addition, both devices may have communication links with other devices and thereby an ad-hoc network may be formed.

Devices of an ad-hoc network not having direct communication links may communicate through intermediate IEEE 802.11b devices. Some of the IEEE 802.11b enabled devices may specifically be connected to a fixed network and provide a gateway functionality to this fixed network. When two IEEE 802.11b devices move further apart, it may not be possible to maintain the connection and thus the communication link may be released. Thus, the configuration of the ad-hoc network continuously changes and furthermore the exact configuration of the network is not known by the individual devices.

As another example, it is expected that ad-hoc networks will be installed in many homes in the future. In particular, it is expected that many consumer devices and domestic appliances will comprise communication facilities in the future. It is also expected that many homes will be provided with wired communication means by which these devices can communicate with each other. In addition, wireless access to the wired communication means is expected thereby allowing devices to connect to the ad-hoc network by the means most suitable for the specific application or device. Thus, it is expected that future homes may comprise functionality allowing for example dish washers, refrigerators and ovens to communicate with each other and other devices such as personal computers, TVs and Personal Digital Assistants.

The configuration of a specific ad-hoc network will naturally depend on which devices are currently connected to the ad-hoc network and may thus change frequently and dynamically.

Although the advent of ad-hoc networks promises functionality and applications not before possible, the dynamic and distributed nature of the ad-hoc networks results in traditional operation and management approaches being unsuitable or suboptimal for ad-hoc networks. For example, not only may the number of devices which are connected change frequently and fast but the capabilities and functionality of the devices may also vary substantially (e.g. a dish washer may be connected to a PDA). A centralized operation and management approach would require undesirably high levels of control communication necessary for a centralized operation and management center to be informed of all changes occurring in the ad-hoc network.

Hence, a centralized approach to configuration management of an ad-hoc network is impractical due to the dynamic variation and the high variety of different types of devices which results in the configuration varying substantially in different physical, logical or architectural localities of the ad-hoc network. For example, an ad-hoc network having a simple configuration backup facility storing the configuration of individual devices will not be sufficient as a lot of data can only be interpreted within the context of location, connections and history of the ad-hoc network.

However, configuration management based on the individual devices is also impractical as each individual device comprises only limited information of the configuration and is further not a permanent element of the network.

Hence, an improved system for configuration management in an ad-hoc network would be advantageous and in particular a system of configuration management that allows for increased flexibility, increased performance, increased functionality, and/or increased reliability of the ad-hoc network would be advantageous.

Accordingly, the Invention preferably seeks to mitigate, alleviate or eliminate one or more of the above mentioned disadvantages singly or in any combination.

According to a first aspect of the invention, there is provided a network device for an ad-hoc network comprising: means for monitoring traffic between a plurality of network elements of the ad-hoc network; means for determining combined configuration information for at least a first and second network element of the plurality of network elements in response to the monitored traffic; and means for storing the combined information.

The ad-hoc network may comprise some permanent or semi-permanent network elements, connections and/or subsections in addition to a dynamic ad-hoc part. The monitoring of traffic may specifically be by intercepting messages between network elements and in particular by intercepting messages between the first and second network element. Intercepted messages may be related to combined configuration information by comparison to a predetermined relationship between messages and combined configuration information. The combined configuration information may for example relate to the first and second network element only or to more network elements or to the configuration of the whole or a subset of the ad-hoc network comprising the first and second network element.

The invention allows for combined configuration information to be determined from monitoring of traffic thereby providing synergy between information of the individual elements. Thus the combined configuration information may for example take into account the configuration of the ad-hoc network, the first network element and/or the second network element. The combined configuration information may thus comprise information that cannot be obtained from the first or second network element individually. It furthermore allows combined configuration information to be determined in a separate network element which allows for the information to be retained in the ad-hoc network even if the first and/or the second network element leaves the ad-hoc network. Thus the information may be retained in the ad-hoc network even if for example one or both of the first and second network elements fails. The combined configuration information may be used for a number of purposes including improving flexibility, functionality and/or performance of the network. An increased robustness and reliability of the ad-hoc network may be achieved as additional information is derived and retained.

According to a feature of the invention, the means for determining the combined configuration information is operable to determine at least a first parameter of the combined configuration information from configuration information of the first network element and configuration information of the second network element. This provides for a low complexity means of determining the combined configuration information and provides combined configuration information which is particularly relevant to the first and/or second network element.

According to another feature of the invention, the first parameter is not a configuration parameter of the configuration information of the first network element or a parameter of the configuration information of the second network element. Preferably, the combined configuration information comprises at least one parameter which is not simply a copy of a configuration parameter of the first or second network element. This parameter may for example be a parameter reflecting a relationship between the first and second network element or between one or both of these and the ad-hoc network. Thus the invention advantageously allows for determination of configuration parameters reflecting information beyond those relating to the individual elements in isolation.

According to another feature of the invention, the first parameter is associated with an interaction between the first network element and the second network element. The invention advantageously allows for determination of combined configuration information which relates to the interaction or relationship between two network elements thus allowing for additional information to be determined.

According to another feature of the invention, the first parameter is associated with an interaction between the first network element and the second network element wherein the combined configuration information comprises a relationship between a parameter of configuration information of the first network element and configuration information of the second network element.

For example, the first parameter may relate parameter values of the first network element to other parameter values of the second network elements. Specifically, a translation between different parameter values and types may be implemented thereby allowing for combined configuration information to be determined from different types of network elements. The parameters need not to refer to the same characteristic but may relate to different characteristics of the first and second network elements. For example, an activity characteristic of a first network element (say a refrigerator being accessed) and a temperature characteristic of another network element (say the temperature of an oven) may be used to determine a user characteristic (such as a possible future activity—e.g. that the user will soon eat a hot meal). Thus combined configuration information may provide additional information that is not available from each of the individual network elements. This allows for increased functionality as an activity may be instigated in response to the detection of this additional combined configuration information.

According to another feature of the invention, the network device further comprises means for monitoring a query message from the first communication element and a reply message from the second communication element, and wherein the means for determining the combined configuration information is operable to determine at least a first parameter of the combined configuration information in response to the query message and the reply message. This provides for a particularly practical and suitable way to implement a way of determining the combined configuration information.

According to another feature of the invention, the network device further comprises means for communicating the combined configuration information from the network device to a network element of the ad-hoc network.

For example the whole or part of the combined configuration information may be downloaded to a new network element entering the ad-hoc network. This allows for the combined configuration information determined to be used by other network elements and therefore may enhance the performance of these network elements.

According to another feature of the invention, the means for communicating the combined configuration information from the network device to the network element of the ad-hoc network is operable to initiate the network element of the ad-hoc network in response to the combined configuration information.

Thus specifically all or part of the combined configuration information may be used to initiate a new network device. This may significantly reduce the time taken for a new network device to obtain configuration information. The combined configuration information may be performed by the network device initiating an information exchange procedure wherein the combined configuration information is communicated to the new network terminal. This information exchange routine may use standard messages, and thus specifically the procedure may be implemented without the new network element being aware of being part of the procedure. For example, if a new network element enters the ad-hoc network, the network device may initiate the transmission of a sequence of messages to the new network element. These messages may be identical to messages which would be received directly from other existing network elements of the ad-hoc network (e.g. the first and second network element). The new network element would thus not be aware that it was communicating with a network device having stored combined configuration information but may believe it is communicating directly with the corresponding network elements. Specifically, the network device may transmit messages at a much higher rate, thereby initiating the new network element very fast.

The new network element may specifically be a replacement device for the first or second network element. This replacement device may thus quickly be updated and initiated with the same configuration information as was previously known to the original network element.

According to another feature of the invention, the network device further comprises means for emulating functionality of the first network element in response to the combined configuration information.

This allows for the network device to automatically replace some or all of the functionality provided by a network element. This may for example significantly improve the reliability and robustness of the system as functionality may be duplicated by the network device. Redundancy is thus introduced whereby the functionality of a failing or a missing network element may still be provided.

According to another feature of the invention, the network device further comprises means for determining an error status in response to the combined configuration information.

For example current operating characteristics may be compared to the combined configuration information and if significant differences are detected this may be taken as an indication of a possible error condition. Hence, improved error detection and thus improved reliability may be achieved of the ad-hoc network.

According to another feature of the invention, the ad-hoc network is a peer to peer network. This provides for a suitable implementation and allows improved configuration in a distributed and non-centralized ad-hoc network.

According to another feature of the invention, the combined configuration information comprises user information related to a common user of the first and second network elements.

This allows for information relating to a user to be determined in response to information from a plurality of network elements and thus allows for improved characterization of the user.

According to another feature of the invention the means for monitoring traffic is operable to monitor traffic in accordance with the eXtensible Markup Language (XML) protocol. This allows for a standardized messaging format to be used as the bases for the monitoring of by the network device.

According to a second aspect of the invention, there is provided an ad-hoc network comprising a plurality of distributed network devices, each network device comprising: means for monitoring traffic between a plurality of network elements of the ad-hoc network; means for determining combined configuration information for at least a first and second network element of the plurality of network elements in response to the monitored traffic; and means for storing the combined configuration information.

According to a third aspect of the invention, there is provided a method of configuration management for an ad-hoc network comprising the steps of monitoring traffic between a plurality of network elements of the ad-hoc network; determining combined configuration information for at least a first and second network element of the plurality of network elements in response to the monitored traffic; and storing the combined configuration information.

These and other aspects, features and advantages of the invention will be apparent from and elucidated with reference to the embodiment(s) described hereinafter.

An embodiment of the invention will be described, by way of example only, with reference to the drawings, in which

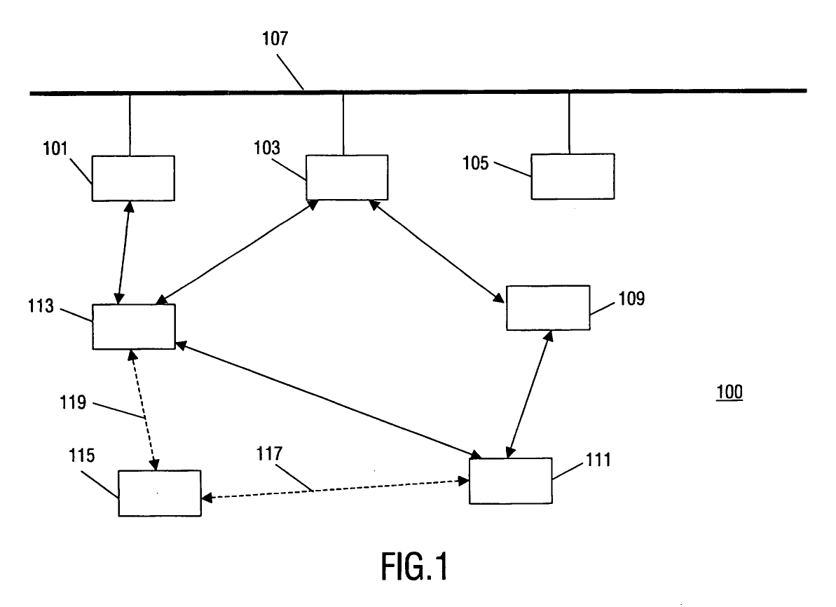

FIG. 1 illustrates an example of a peer to peer ad-hoc network to which an embodiment of the invention may be applied;

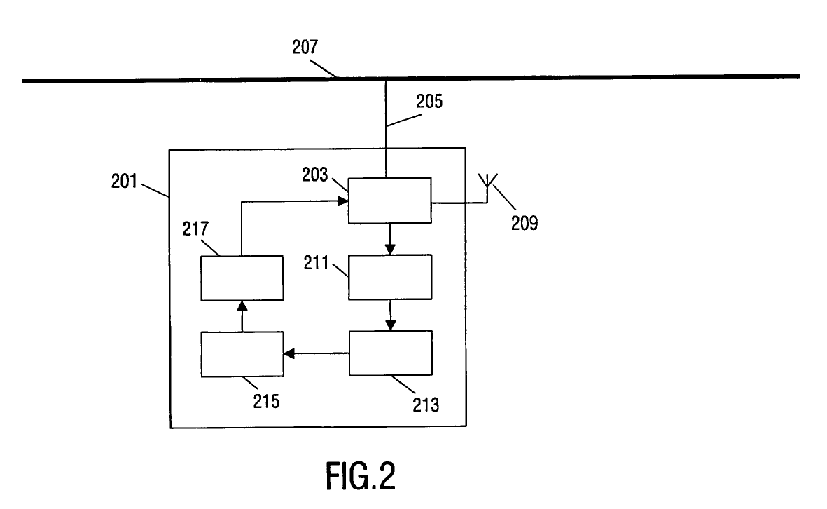

FIG. 2 illustrates a block diagram of a network device in accordance with an embodiment of the invention.

The following description focuses on an embodiment of the invention applicable to a predominantly peer to peer ad-hoc network but it will be appreciated that the invention is not limited to this application but may be applied to many other applications and types of ad-hoc networks.

FIG. 1 illustrates an example of a peer to peer ad-hoc network to which an embodiment of the invention may be applied. In the given example, a first group of network elements 101, 103, 105 are connected together through a fixed communication medium 107. The fixed communication medium may for example be a twisted wire or a coax cable transmission line or may be an optical fiber.

In the preferred embodiment, the ad-hoc network is a domestic ad-hoc network and the fixed communication medium is specifically a wire communication line 107, which is distributed throughout different rooms of a house. In the preferred embodiment, the different network elements may for example be domestic appliances, such as refrigerators, ovens or washing machines, consumer equipment, such as TVs, video recorders or HiFi equipment, or computers, such as Personal Computers (PCs) or personal Digital Assistants (PDAs).

The wire communication line 107 comprises many contact points at which network elements can be connected to the wire communication line 107 and each network element of the first group of communication elements 101, 103, 105 is connected to one of these. Network elements may be dynamically connected and removed from the wire communication line 107 and the configuration of the ad-hoc network 100 may thus change dynamically. The ad-hoc network comprises no central controller or configuration management center for controlling the configuration and therefore the dynamic variations in the configuration does not require interaction with any central devices. It will be clear to the person skilled in the art that any suitable algorithm for communication or setting up communication links between network elements in an ad-hoc network may be used without detracting from the invention.

In addition to communication over the wire communication line 107 the described ad-hoc network comprises functionality for communication over the air using radio signals. Specifically, a second group of network elements 101, 103, 109, 111, 113, 115 comprise IEEE 802.11b communication means which are operable to communicate with other IEEE 802.11b enabled devices over relative short distances of typically tens of meters. Note that in the described example, some network elements 101, 103 comprise functionality for both wired and wireless communication.

In the specific illustrated example, radio links are formed between network terminals 101 and 113, 103 and 113, 103 and 109, 111 and 113 and between 111 and 113. In the described example, network terminal 111 may for example communicate with network terminal 105 by using network terminals 109 and 103 as intermediate network nodes.

If, for example, a new IEEE 802.11b capable network element enters the vicinity of the ad-hoc network, the network elements may detect each other and set up new communication links. Thus, for example, a new network element 115 may enter the ad-hoc network and new communication links 117, 119 may be set up with existing network elements 111, 113 respectively. When the network element 15 moves away, the communication links 117, 119 cannot be maintained and are released.

Many of the network elements of the described ad-hoc network may be mobile devices such as PDAs, mobile phones, property tags etc and as the different network elements move relative to each other, different communication links may continuously be set up and released as the conditions allow. Thus the configuration of the ad-hoc network continually changes to reflect the current communication possibilities and the distribution of network elements.

Furthermore, the different network elements may have very different functionality and capabilities and operate in different operating modes at different times. Therefore the configuration of the network does not just change because of the interconnections changing but also because the functionality and capability of the involved devices change. Thus for example, a given functionality may sometimes be available in a given part of the ad-hoc network and other times may not be available. For example, if the network element 115 is a printer, the configuration of the ad-hoc network 100 may change such that the printing functionality may be available at different network positions depending on, not only the position of the printer itself, but also on the position of other network elements.

The preferred embodiment seeks to provide improved configuration management in an ad-hoc network. FIG. 2 illustrates a network device 201 in accordance with an embodiment of the invention.

The network device 201 is in the preferred embodiment a passive node of the ad-hoc network 100. The network device 201 monitors the traffic in the surrounding locality of the network device 201 and is operable to interpret control data flowing between network elements and to extract and store the information contained. The network device 201 determines configuration information related to at least two network elements and may specifically build a configuration history for the system as a whole or for a particular subsystem associated with the network device.

In the preferred embodiment, the network device 201 comprises an interface 203 which is operable to interface with the ad-hoc network 100. Specifically, the interface is operable to monitor communication in communication media used by the ad-hoc network. The interface 203 may further be operable to setup communication links with network elements of the ad-hoc network 100 and to communicate with network elements through these communication links.

In the preferred embodiment, the interface 203 comprises functionality for interfacing to a wired communication medium 207 through a wire connection 205. Specifically, the wired communication medium 207 may be the wire communication line 107 of the ad-hoc network 100 of FIG. 1. In the preferred embodiment, the network device 201 further comprises functionality for interfacing to a wireless communication medium, and specifically the network device 201 comprises IEEE 802.11b functionality for receiving and decoding IEEE 802.11b signals from other network elements. For this purpose, the interface 203 is connected to an antenna 209.

The interface 203 is connected to a traffic monitoring processor 211 which is operable to monitor the ongoing traffic of the wired and wireless communication media. Specifically, the traffic monitoring processor 211 receives and decodes all control messages detected by the interface. Thus the traffic monitoring processor 211 decodes all control messages that can be received by the interface 203 regardless of which network elements the messages are transmitted between.

The control messages may be all messages that include any information which may relate to configuration information of any of the network elements or of a subsection or the whole of the ad-hoc network 100.

The traffic monitoring processor 211 is coupled to a configuration processor 213. The configuration processor 213 is operable to determine combined configuration information for at least a first and second network element of the ad-hoc network 100 in response to the monitored traffic.

The combined configuration information may for example comprise information related to relationships, associations, comparisons, correlations, interdependencies, interactions, interconnections or commonality of characteristics associated with the first and second network element. Specifically, one or more parameters of the combined configuration information may be determined as a function of a first parameter of the first network element and a second parameter of the second network element.

In the preferred embodiment, the configuration processor 213 determines the combined configuration information in response to a parameter of the first and second network element. In some embodiments, the combined configuration information comprises user information related to a common user of the first and second network elements.

For example, a control message may be intercepted from a first network element being a wireless telephone comprising information indicating a user identity and an associated telephone number. Similarly, a control message may be intercepted by a second network element being an email terminal comprising a user identity and an associated email address. The configuration processor 213 may compare the user identity and if a match is detected, it will generate combined configuration information comprising an association of the telephone number with the email address. Thus, configuration processor 213 derives a parameter (the association of telephone number and email address) which is not available in either of the two network elements. Thus, the parameters of the combined configuration information preferably comprise parameters which are not parameters of the individual network elements but are generated by consideration of two or more network elements.

The configuration processor 213 may also determine combined configuration information in response to the interaction between two network elements. For example, if in the example of FIG. 1, network element 105 is intending to communicate with network element 109, it may send a request message to network element 101 and 103 requesting if they can act as an intermediate node for the communication with network element 109. In response to this query message, network element 101 may respond with a negative reply message because no direct link exists between network element 101 and 109. However, network element 103 responds by a positive reply message as it has a direct connection to network element 109. Communication between network element 105 and 109 may then initiate through network element 103.

The network device 201 may intercept these messages and accordingly include in the combined configuration information that communication between network element 105 and 109 is possible through network element 103 but not by only using network element 101 as an intermediate. However, the network device 201 may also detect similar message flows between network element 113 and network element 111 and therefrom derive configuration information that network element 109 can be reached from network element 113 through network element 111. In addition, it may detect communication messages between network element 101 and network element 113 and therefrom conclude that a communication link exists between these two. Accordingly, the configuration processor 213 has information that communication links exists between network element 105 and 101, between network element 101 and 113, between network element 113 and 111 and between network element 111 and 109. Thus the configuration processor 213 may include the alternative route of network elements 105, 101, 113, 111 and 109 in combined configuration information related to network elements 105 and 109.

In this case, if network element 103 malfunctions or leaves the ad-hoc network, the alternative route may immediately be set up using the combined configuration information related to network elements 105 and 109. In the preferred embodiment, the combined configuration information thus comprises additional information, which is not available at each individual network element, and which cannot be derived from the information available to each network element.

Thus in this example the network device 201 listens in on the communication between other network elements in the environment and integrates this information to develop a detailed map of its local environment. New devices can thus be informed about the local environment, immediately fitting in without user interaction. Furthermore, if a connected device breaks down and is replaced, the network device 201 may quickly set up alternative communication routes.

The configuration processor 213 is further coupled to a data store 215 wherein the combined configuration information may be stored.

In the preferred embodiment, the network device 201 furthermore comprises a communication processor 217 which is operable to communicate the combined configuration information from the network device 201 to a network element of the ad-hoc network 100. This network device may then use the combined configuration information in any suitable way such as to provide increased functionality based on the additional information.

Hence, in accordance with the preferred embodiment combined configuration information related to more than one network element is generated in a network device 201. The combined configuration information thus comprises information which extends beyond the sum of the configuration information available in each of the network elements. For example, the combined configuration information may comprise information, which not only relates to the individual network elements, but also to the interaction of the network elements. The combined configuration information allows for improved functionality, reliability and performance of the ad-hoc network.

The combined configuration information may be used for many different purposes and to achieve many different advantages. In the following some specific embodiments and applications are described by way of example only.

In some embodiments, the combined configuration information is used to quickly initiate new network elements. Preferably, in this embodiment, the combined configuration information may act as a back up facility thereby allowing new network elements to quickly be integrated in the network. Specifically, if a network element fails, a new network element may quickly be initialized by the combined configuration information and thus any disruption to the ad-hoc network may be minimized.

For example, an ad-hoc network that has a simple backup facility which only backs up the current configuration of the individual network elements will not yield optimal performance as a lot of data can only be interpreted within the context of location, connections and history. In contrast, the stored combined configuration information allows the configuration of the ad-hoc network as a whole or of subsections of the ad-hoc network to be stored.

If a network element breaks down and an identical replacement is not available the backup of only the configuration of the network element may be of limited use. Also without the presence of the network device, the complete restoration of its functionality in the context of the ad-hoc network will be time and power consuming.

Using the previous example of FIG. 1, if network element 103 fails, the communication between network element 105 and 109 will continue through network elements 101, 113 and 111, which is a significantly more resource demanding route. When network element 103 is replaced, this will not be aware of the communication between element 105 and 109 which will continue through network elements 101, 113, 109. However, if the combined configuration information is downloaded to network element 103 this may cause network element 103 to send a message to network element 105 requesting it to reinitialize the communication through network element 103.

In some embodiments, the network device 201 further comprises means for emulating the functionality of another device. The network device 201 may thus copy or approximate the performance of a failing network element. Specifically, the network device 201 may intercept messages to the failing network element and generate reply messages that the failing device would have generated. In the specific example, if network element 103 fails the network device 201 may receive all messages from network element 105 and forward these to network element 109.

If complete replacement of the functionality of the failing device can not be reconstructed, the system can use the combined configuration information to resurrect the functionality of a predecessor or an approximation thereof.

Thus, in general, the ad-hoc network may become more reliable and the robustness of the system will be greatly enhanced. Failure of any device can be easily dealt with, either by replacing the defect device and restoring its configuration and context, or by accurately replacing the functionality of the device. The speed with which the complete functionality of a failing device can be taken over by other devices (identical or not) is greatly increased.

Furthermore, the network device may comprise functionality for determining an error status in response to the combined configuration information. For example, if behavior that differs from the behavior expected from the combined configuration information is detected, this may be an indication that a network element may possibly be failing.

Thus it may become easier to detect and determine the cause of errors in the ad-hoc network.

The network device may be a dedicated device or the functionality of the network device may be integrated with a network element, a generic device or a device also comprising other functionality.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A network device (201) for an ad-hoc network (100) comprising:
means (211) for monitoring traffic between a plurality of network elements of the ad-hoc network;
means (213) for determining combined configuration information for at least a first and second network element of the plurality of network elements in response to the monitored traffic; and
means (215) for storing the combined information.

2. A network device (201) as claimed in claim 1 wherein the means (213) for determining the combined configuration information is operable to determine at least a first parameter of the combined configuration information from configuration information of the first network element and configuration information of the second network element.

3. A network device (201) as claimed in claim 2 wherein the first parameter is not a parameter of the configuration information of the first network element nor a parameter of the configuration information of the second network element.

4. A network device (201) as claimed in claim 2 wherein the first parameter is associated with an interaction between the first network element and the second network element.

5. A network device (201) as claimed in claim 2 wherein the first parameter is associated with an interaction between the first network element and the second network element and the combined configuration information comprises a relationship between a parameter of configuration information of the first network element and configuration information of the second network element.

6. A network device (201) as claimed in claim 1 further comprising means for monitoring a query message from the first communication element and a reply message from the second communication element and wherein the means for determining the combined configuration information is operable to determine at least a first parameter of the combined configuration information in response to the query message and the reply message.

7. A network device (201) as claimed in claim 1 further comprising means (217) for communicating the combined configuration information from the network device to a network element of the ad-hoc network.

8. A network device (201) as claimed in claim 7 wherein the means (217) for communicating the combined configuration information from the network device (205) to the network element of the ad-hoc network is operable to initiate the network element of the ad-hoc network in response to the combined configuration information.

9. A network device (201) as claimed in claim 1 further comprising means for emulating functionality of the first network element in response to the combined configuration information.

10. A network device (201) as claimed in claim 1 further comprising means for determining an error status in response to the combined configuration information.

11. A network device (201) as claimed in claim 1 wherein the ad-hoc network (100) is a peer to peer network.

12. A network device (201) as claimed in claim 1 wherein the combined configuration information comprises user information related to a common user of the first and second network elements.

13. A network device (201) as claimed in claim 1 wherein the means (211) for monitoring traffic is operable to monitor traffic in accordance with the extensible Markup Language (XML) protocol.

14. An ad-hoc network (100) comprising a plurality of distributed network devices (201), each network device (201) comprising:
means (211) for monitoring traffic between a plurality of network elements of the ad-hoc network;
means (213) for determining combined configuration information for at least a first and second network element of the plurality of network elements in response to the monitored traffic; and
means (215) for storing the combined configuration information.

15. A method of configuration management for an ad-hoc network (100) comprising the steps of:
monitoring traffic between a plurality of network elements of the ad-hoc network;
determining combined configuration information for at least a first and second network element of the plurality of network elements in response to the monitored traffic; and
storing the combined configuration information.

16. A computer program enabling the carrying out of a method according to claim 15.

17. A record carrier comprising a computer program as claimed in claim 16.
